(19) United States
(12) Patent Application Publication
(10) Pub. No.: US 2016/0353027 A1
(43) Pub. Date: Dec. 1, 2016

(54) IMAGE CORRECTION CIRCUIT AND IMAGE CORRECTION METHOD

(71) Applicant: Samsung Electro-Mechanics Co., Ltd., Suwon-si (KR)

(72) Inventors: Hee Yong YOO, Suwon-si (KR); Myung Gu KANG, Suwon-si (KR)

(73) Assignee: Samsung Electro-Mechanics Co., Ltd., Suwon-si (KR)

(21) Appl. No.: 15/075,767

(22) Filed: Mar. 21, 2016

(30) Foreign Application Priority Data
May 29, 2015 (KR) 10-2015-0076496

(51) Int. Cl. H04N 5/232; G06T 5/00; H04N 5/225

(52) U.S. Cl. CPC H04N 5/23287; H04N 5/23258; H04N 5/2257; G06T 5/003

(57) ABSTRACT

An image correction circuit includes: a motion sensor configured to generate motion data corresponding to movement of a camera module during capturing of an image; and a controller configured to post-correct the image using the motion data to remove blurring of the image caused by the movement of the camera module.

### CROSS-REFERENCE TO RELATED APPLICATION(S)

This application claims the benefit under 35 USC 119(a) of Korean Patent Application No. 10-2015-0076496 filed on May 29, 2015, in the Korean Intellectual Property Office, the entire disclosure of which is incorporated herein by reference for all purposes.

### BACKGROUND

1. Field

The following description relates to an image correction circuit and an image correction method performed by the image correction circuit.

2. Description of Related Art

Commonly, in digital imaging systems, an image received through an imaging device (or an image pickup device) is processed by a digital signal processor. The processed image is compressed to generate an image file, and the image file may be stored in a memory.

The digital imaging system may display an image of an image file received through an image pickup device or an image of an image file stored in a storage medium, on a display device such as a liquid crystal display (LCD). However, when a user captures an image, movement and rotation of a camera due to user hand-shake, or the like, during an exposure time of an aperture of the camera creates blurring of captured images. That is, the digital imaging system such as a camera may experience movement or wobbling due to user hand-shake. Such movement or wobbling may lead to shaking of an image input through the image pickup device, which may result in failure to capture clear images.

Thus, in order to prevent an imaging failure due to hand-shake, a digital imaging system includes an anti-hand-shake function. That is, when hand-shake occurs, an angular velocity, or the like, of a camera is detected by a gyro sensor, or the like, installed in the camera, a movement direction and a movement distance of a camera lens are calculated on the basis of the detected angular velocity, and the lens is subsequently moved by an amount equal to the movement distance by an actuator. Thereafter, optical image stabilization (OIS) is performed on the lens in a moved position through feedback control using an output signal of a Hall sensor.

The aforementioned OIS scheme includes a lens shifting scheme and an image sensor shifting scheme. The lens shifting scheme is a method of canceling out movement by moving the lens in a direction opposite to a direction in which the camera is moved when the gyro sensor attached to the camera senses the movement of the camera. The image sensor shifting scheme is a method of canceling out movement by moving an image sensor in a direction opposite to a direction in which the camera is moved when the gyro sensor attached to the camera senses the movement of the camera. Small devices commonly employ the lens shifting scheme in an OIS module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an image correction circuit includes: a motion sensor configured to generate motion data corresponding to movement of a camera module during capturing of an image; and a controller configured to post-correct the image using the motion data to remove blurring of the image caused by the movement of the camera module.

The motion sensor may include: an angular velocity sensor configured to generate angular velocity data representing a change in angular velocity based on the movement of the camera module; and a position sensor configured to generate position data of a lens upon detecting a position of the lens.

The controller may be configured to generate movement control data by determining a movement direction and a movement distance of the lens according to an angle obtained by integrating the angular velocity data.

The controller may be configured to remove blurring of the image using an error between the movement control data and the position data.

The controller may be configured to detect the error by comparing the movement control data and the position data, and calculate an image trajectory regarding the error, the image trajectory including information related to three axis directions.

The controller may be configured to estimate a point spread function based on the image trajectory, and remove blurring from the image by applying deconvolution to the point spread function.

The controller may include: a first processor configured to generate movement control data including information regarding a movement direction and a movement distance of the lens using an angle calculated by integrating the angular velocity data; and a second processor configured to detect an error using a differential value obtained by comparing the movement control data and the position data, generate a motion trajectory according to coordinates corresponding to the error, and apply deconvolution to a point spread function estimated on the basis of the image trajectory.

The position sensor may include: a first Hall sensor configured to sense an x-axis position of the lens; a second Hall sensor configured to sense a y-axis position of the lens; a third Hall sensor configured to sense a z-axis position of the lens.

According to another general aspect, an image correction method includes: performing a data generation operation including generating position data including movement control data of a lens and position information related to the lens according to movement of a camera module during capturing of an image; and performing a blurring removal operation including post-correcting the image using the movement control data and the position data to remove blurring of the image caused by the movement of the camera module.

The performing of the data generation operation may further include: generating angular velocity data representing a change in angular velocity of the movement of the camera module; calculating an angle by integrating the angular velocity data, and generating the movement control data by determining a movement direction and a movement distance of the lens on the basis of the calculated angle; and detecting a position of the lens to generate the position data.

The performing of the blurring removal operation may further include: detecting an error between the position data and the movement control data to calculate an error path; estimating a point spread function on the basis of the path of the error; and removing blurring of the image by applying deconvolution to the point spread function.

The detecting of the error may include detecting the error using a differential value obtained by comparing the movement control data and the position data. The calculating of the error path may include detecting a three-dimensional path according to coordinates corresponding to the error.

According to another general aspect, a camera module includes: an image sensor configured to capture an image; and a controller configured to receive motion data corresponding to movement of the camera module during the capturing of the image, and post-correct the image using the motion data to remove blurring of the image caused by the movement of the camera module.

The motion data may include angular velocity data representing a change in angular velocity based on the movement of the camera module, and position data of a lens.

The controller may be configured to generate movement control data by determining a movement direction and a movement distance of the lens according to an angle obtained by integrating the angular velocity data. The controller may be configured to remove blurring of the image using an error between the movement control data and the position data.

The controller may be configured to: calculate an image trajectory regarding the error, the image trajectory including information related to three axis directions; estimate a point spread function based on the image trajectory; and remove blurring from the image by applying deconvolution to the point spread function.

Other features and aspects will be apparent from the following detailed description, the drawings, and the claims.

### BRIEF DESCRIPTION OF THE DRAWINGS

FIG. 1 is a block diagram illustrating an example of an image correction circuit.

FIG. 2 is a view illustrating an example of a position sensor.

FIG. 3 is a view illustrating an example of a movement distance of a lens.

FIG. 4 are graphs illustrating examples of lens movement control data and lens position data in an axial direction.

FIG. 5 is a view illustrating an example of a path (or a trajectory) of lens movement error.

FIG. 6 is a flow chart illustrating an example of an image correction method.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views. In the drawings, for example, due to manufacturing techniques and/or tolerances, modifications of the shape shown may be estimated. Thus, embodiments should not be construed as being limited to the particular shapes of regions shown herein, for example, to include a change in shape results in manufacturing. The following embodiments may also be constituted by one or a combination thereof.

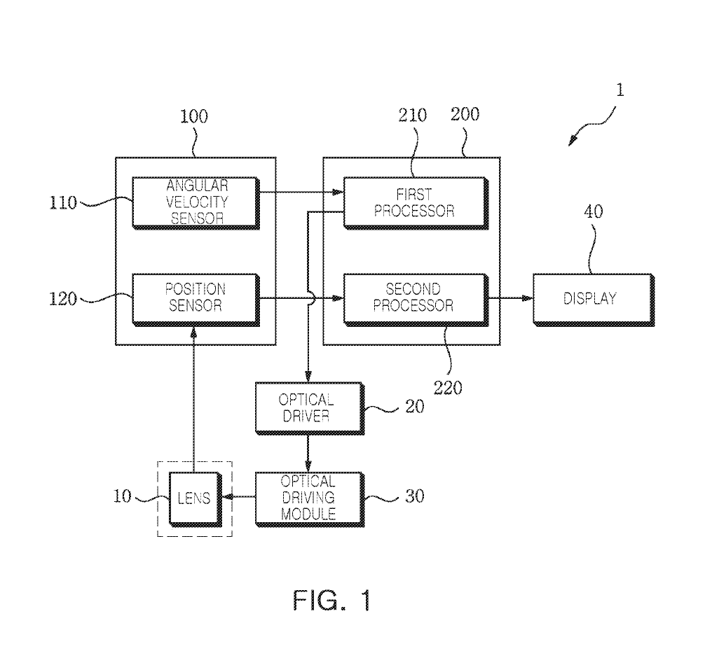

As illustrated in FIG. 1, a camera module 1 includes an image correction circuit that includes a motion sensor 100 including an angular velocity sensor 110 and a position sensor 120, and a controller 200 including a first processor 210 and a second processor 220. The image correction circuit further includes a display 40, an image sensor 50, a lens 10, an optical driver 20 and an optical driving module 30. Although the lens 10 is described as being included in the image correction circuit, the lens 10 may be provided within the camera module 1, but external to the image correction circuit, as indicated by the dashed box enclosing the lens 10.

The image correction circuit may be implemented in mobile multi-functional devices such as digital cameras, smartphones, a tablet PCs, personal digital assistants (PDA), portable multimedia players (PMP), laptop computers, and desktop computers, but is not limited to such implementations.

The lens 10 may include a zoom lens, a focusing lens, or a compensation lens, and causes light flux from a subject to be incident on the image sensor 50. When the camera module 1 moves during an image capturing period, the lens 10 is moved by the optical driving module 40 (to be described hereinafter) in order to accurately image the subject on the image sensor 50.

The image sensor 50 optically processes light from the subject to detect an image of the subject. In a case in which the image is blurred due to movement of the camera module 1, the image sensor 50 transmits the blurred image to the first processor 210 (to be described hereinafter). The image sensor 50 may be a charge coupled device (CCD) or a complementary metal-oxide semiconductor (CMOS) configured to convert an optical signal of incident light into an electrical analog signal.

The motion sensor 100 may be provided internally in or externally of the camera module 1, and generates motion data corresponding to movement of the camera module 1. That is, the motion sensor 100 senses a change in angular velocity with respect to movement of the camera module 1 and a position of the lens 10 is moved to correspond to the movement of the camera module 1.

The image capturing period refers to a time during which a shutter is opened and the image sensor 50 is exposed to light incident through the lens 10. Also, movement of the camera module 1 refers to movement caused due to user hand-shake when the user captures an image using the camera module 1.

The angular velocity sensor 110 is a sensor configured to detect an amount of torque applied from an object and measure an angular velocity. For example, angular velocity data corresponding to movement of the camera module 1 is generated. The angular velocity sensor 110 senses a change in angular velocity of movement with respect to a pitch axis, a yaw axis, and a roll axis. For example, the pitch axis, the yaw axis, and the roll axis correspond to an x axis, a y axis, and a z axis, respectively. Thus, the angular velocity sensor 110 may be a gyro sensor capable of sensing a change in angular velocity of movement in three axis directions.

In order to cancel noise and a direct current (DC) offset included in an output signal, the angular velocity sensor 110 may further include a high pass filter (HPF) (not shown) and a DC offset canceller (not shown).

The position sensor 120 senses a position of the lens 10 during the image capturing period to generate position data including position information related to the lens 10. The position sensor 120 may be a Hall sensor configured to sense a change in a position of the lens 10 using a Hall effect in which a voltage is changed according to strength of a magnetic field.

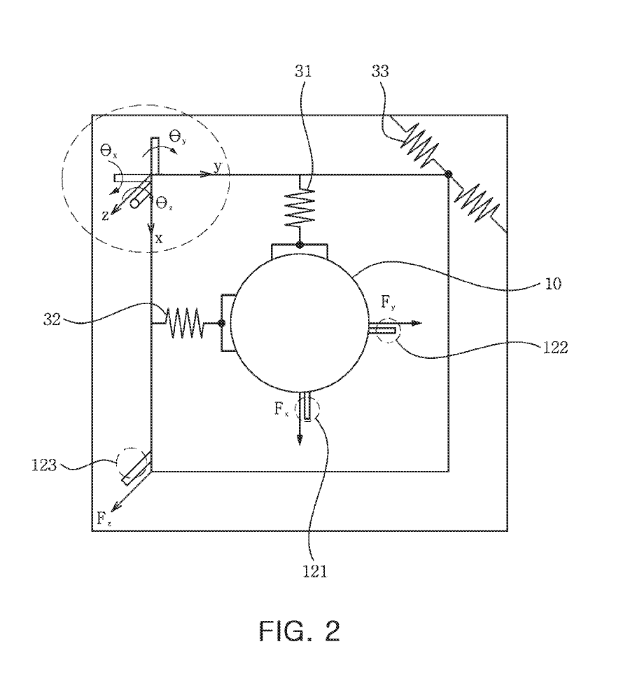

As illustrated in FIG. 2, in order to sense a position of the lens 10 in three axis directions, a first Hall sensor 121 (configured to sense in the x-axis direction), a second Hall sensor 122 (configured to sense in the y-axis direction), and a third Hall sensor 123 (configured to sense in the z-axis direction) are provided in the lens 10. Thus, the first to third Hall sensors 121, 122, and 123 sense a three-dimensional (3D) position of the lens 10 moved by first, second and third actuators 31, 32, and 33 during the image capturing period, and calculate position data stored in the form of 3D (x, y, and z axes) coordinates on the basis of the sensed 3D position of the lens 10.

The controller 200 includes the first processor 210 and the second processor 220. In order to remove blurring from the image caused by movement of the camera module 1, the controller 200 post-corrects the image using the motion data.

Blurring refers to a residual image of an object created in an image and a streaking effect caused due to the residual image when a subject moving rapidly is imaged or when user hand-shake occurs during imaging. Thus, when the camera module 1 is moved due to hand-shake, blurring occurs, resulting in failure to obtain a clear image and a degradation of image quality. Thus, the controller 200 removes blurring of the image using motion data to provide a clear image to the user and enhance image quality.

In detail, the controller 200 calculates an angle by integrating angular velocity data generated by the angular velocity sensor 110, and determines a movement direction and a movement distance of the lens 10 based on the angle to correspond to movement of the camera module 1. The controller 200 then generates movement control data including the movement direction and the movement distance of the lens 10.

The controller 200 compares the movement control data and the position data received from the position sensor 120 to detect an error between the movement control data and the position data, and calculates a 3D path (a motion trajectory) regarding the error. The 3D path regarding the error includes information related to the three axis directions (x, y, and z axes).

Also, the controller 200 estimates a point spread function (PSF) based on the 3D path regarding the error, and applies deconvolution to the PSF to remove blurring from the image.

The movement control data, the 3D path regarding the error, the PSF, and the deconvolution will be described in detail when the first and second processors 210 and 220 are described hereinafter.

The first processor 210 integrates the angular velocity data generated by the angular velocity sensor 110 to calculate an angle and generates the movement control data including the information related to the movement direction and the movement distance of the lens 10 using the calculated angle. Also, the first processor 210 transmits the movement control data and the blurred image to the second processor 220.

In order to integrate the angular velocity data received from the angular velocity sensor 110, the first processor 210 includes an integrator (not shown). The integrator calculates an angle for the lens 10 to move by integrating the angular velocity data, and integrates angular velocity data in each of the x, y, and z axes. The integrator may be realized by software or hardware.

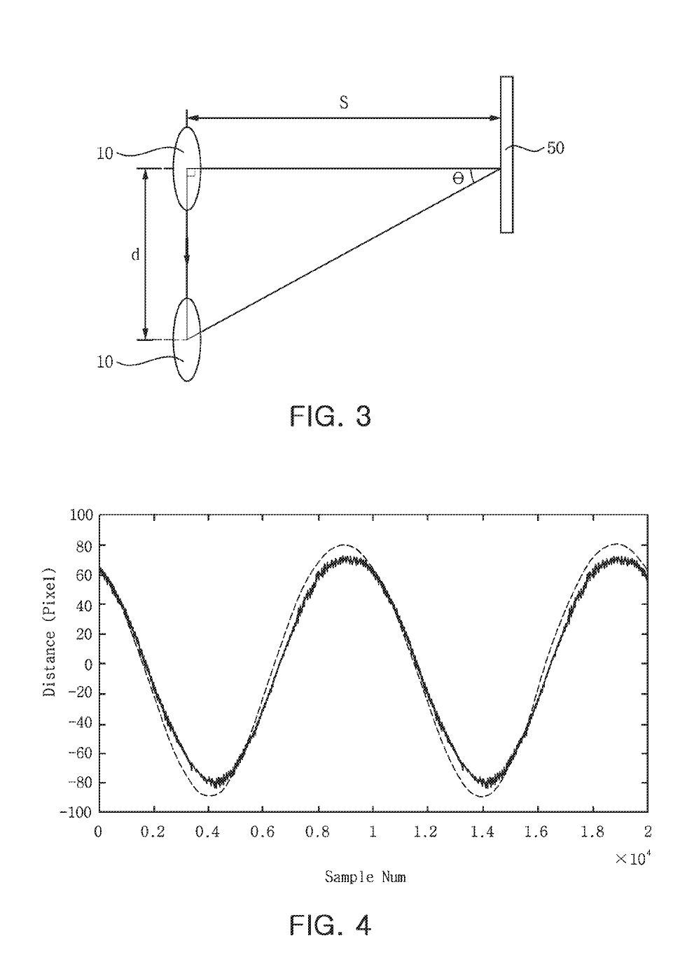

In order to move the lens 10 to correspond to movement of the camera module 1, information regarding a direction and a distance by which the lens 10 is to move is required. The movement direction may be determined according to an angle θ, and the movement distance may be obtained through Equation 1 below. In detail, as illustrated in FIG. 3, when the lens 10 moves by the angle θ from an initial position of the lens 10, a movement distance d of the lens 10 is calculated as expressed by Equation 1 on the basis of a right-angled triangle relationship established among the initial position and a target movement position of the lens 10 and the image sensor 50.

Movement distance (d)=focal length (s)×tan θ. [Equation 1]

The movement distance d refers to a distance over which the lens 10 is to move, the focal length S refers to a distance between the initial position of the lens 10 and the image sensor 50. The angle θ refers to an angle calculated by integrating the angular velocity data. Here, however, the movement distance may not necessarily be calculated only through Equation 1 and any method known in the art may be applied to an example in the present disclosure.

The movement control data refers to position information related to a position to which the lens 10 is to be moved in order to correspond to movement of the camera module 1 during the image capturing period. That is, the movement control data refers to a target position of the lens, rather than a position that the lens 10 has actually reached. The movement control data includes target position information related to a position of the lens 10 to be reached during the image capturing period, in the form of 3D (x, y, and z axis) coordinates.

The optical driver 20 generates a driving voltage and a control signal applied to the optical driving module 30 in order to move the lens 10 according a control signal based on the position control data. The optical driving module 30 includes the first to third actuators 31, 32, and 33, which may each include a voice coil motor (VCM) or a piezoelectric device. The first actuator 31 controls movement of the lens 10 in the x-axis direction, the second actuator 32 controls movement of the lens 10 in the y-axis direction, and the third actuator 33 controls movement of the lens 10 in the z-axis direction.

The second processor 220 calculates an error by differentiating the position data and the movement control data, and calculates a 3D path regarding the error. As discussed above, the position data includes position information related to the lens 10 being moved by the optical driving module 30 during the image capturing period, and the movement control data includes movement information for the lens 10 to move to correspond to movement of the camera module 1 during the image capturing period.

In other words, the position data includes position information regarding a position to which the lens 10 has actually moved, while the movement control data includes target position information related to the target position of the lens 10. Thus, ideally, the position data and the movement control data should match. However, in actual driving, the position data and the movement control data do not match each other due to noise or a mechanical error, causing blurring in an image.

In the graphs illustrated in FIG. 4, the horizontal axis represents time, and the vertical axis represents movement displacement of the lens 10. The dotted line represents a curve regarding movement control data in one direction (e.g., in the direction of the x-axis, y-axis, or z-axis), and the solid line represents a curve regarding position data in one direction. As illustrated in FIG. 4, when the position data and the movement control data do not accurately match, the lens 10 fails to move to accurately correspond to movement of the camera module 1, creating blurring of an image. Thus, blurring of the image is removed using an error detected by comparing the position data and the movement control data.

The error is calculated by comparing the movement control data and the position data. Since information related to the movement control data and the position data is stored in the form of coordinates, the movement control data and the position data may be compared, and an error therebetween may be obtained by subtracting the position data from the movement control data or by subtracting the movement control data from the position data. However, the error may not necessarily be calculated using the differential value between the position data and the target data and any method may be employed to calculate the error as long as pieces of data are compared.

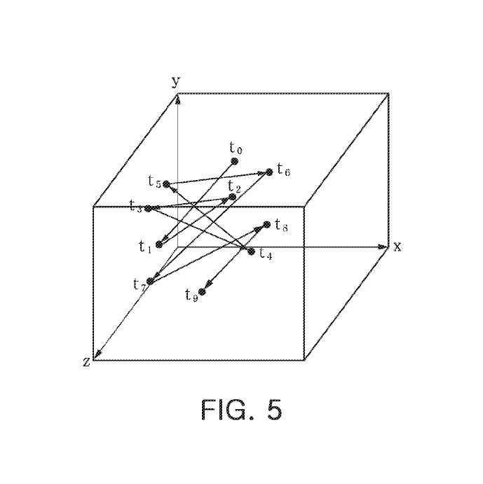

FIG. 5 is a view illustrating a 3D path detected on the basis of an error. For example, on the assumption that target data is subtracted from position data, in a case in which coordinates of the position data are (3,8,9) and coordinates of the movement control data are (2,6,2) at a point in time t1, error data is (1,2,7). In a case in which coordinates of the position data are (8,7,5) and coordinates of the movement control data are (5,2,1) at a point in time t2, error data is (3,5,4). A 3D path regarding errors from t0 to t9 is detected in the same manner.

The second processor 220 estimates a point spread function (PSF) on the basis of the 3D path regarding the errors. The point spread function refers to a function representing lack of clarity when a point of a subject is not reproduced as an actual point in an image. As illustrated in FIG. 5, a number of points distributed in the 3D path regarding an error may be recognized, and a point spread function may be estimated on the basis of the distributed points. A specific unit for estimating the point spread function is known by a person having skill in the art to which the disclosure pertains, and thus, a detailed description of a unit for estimating the point spread function will be omitted.

The second processor 220 removes blurring from the image by applying a deconvolution algorithm to the estimated point spread function.

B=I*K [Equation 2]

Here, B denotes the blurred image, I denotes the point spread function, K denotes a sharp image without blurring, and * denotes convolution. With reference to Equation 2, it can be seen that the blurred image is equal to application of convolution to the point sprad function and the sharp image. Thus, when the deconvolution algorithm of the point spread function is applied to the blurred image, the sharp image without blurring may be obtained.

The deconvolution algorithm includes a Wiener filter scheme using a spatial domain and an L2 scheme and a Levin scheme using a frequency domain. All of the stated schemes may be applied. Also, without being limited thereto, any technique known in the art to which the disclosure pertains may be applied to deconvolution algorithm application scheme. Here, since the deconvolution algorithm application scheme is well known to a person having skill in the art to which the disclosure pertains and is a known art, a detailed description thereof will be omitted.

The controller 200, the first processor 210, and the second processor 220 may include an algorithm for performing the function described above, and may be realized using firmware, software, or hardware (for example, a semiconductor chip or an application-specific integrated circuit (ASIC)).

The display 40 receives a blurring-removed image from the second processor 220 and outputs the received image to a user. The display 40 may be a liquid crystal display (LCD), a plasma display panel (PDP), electroluminescent display (ELD), or an active matrix organic light-emitting diode (AMOLED) display, but is not limited thereto.

In the course of moving the lens 10 to correspond to movement of the camera module 1, an error may occur between the movement control data and the position data resulting in the presence of fine blurring remaining in the image even after application of optical image stabilization (OIS). Thus, in order to remove the fine blurring, a path based on the error between the movement control data and the position data is detected, and the deconvolution algorithm is applied to the point spread function estimated on the basis of the path regarding the error. As a result, the user may view a sharp image through the display 40.

Also, the use of movement data and position data in a 2D space may lead to a limitation in restoring a sharp image because a value of the other remaining axis in a 3D space is not considered. However, since blurring is removed by detecting the motion trajectory regarding the error through movement control data including 3-axis (x, y, and z axes) directional information and 3-axis directional position information related to the lens 10 during the image capturing period, the blurred image may be corrected to a sharper image.

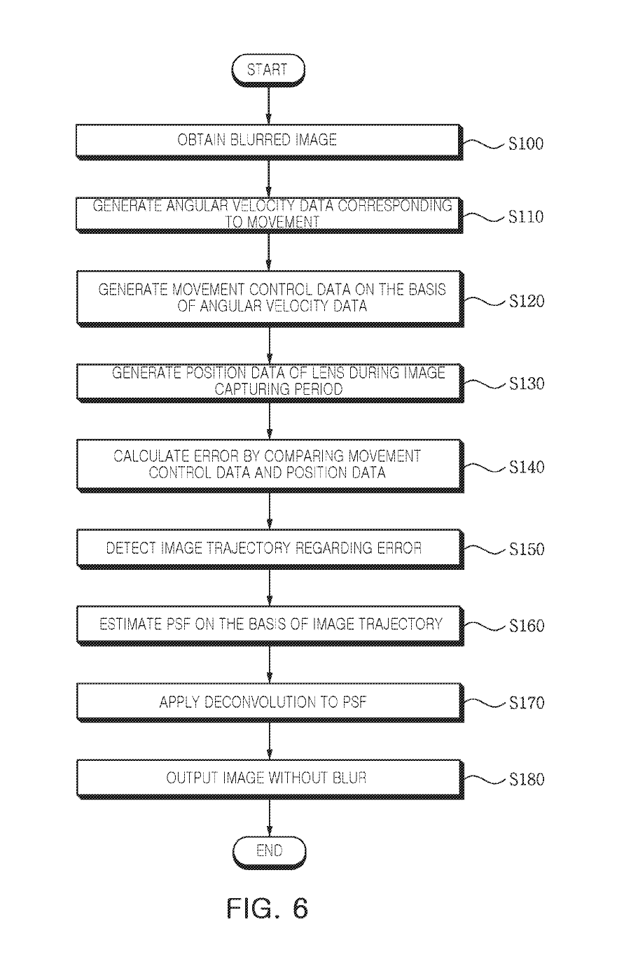

Hereinafter, an image correction method including the configuration described above will be described with reference to FIG. 6. In the following descriptions, components or parts similar to or the same as those described above will be omitted or briefly described.

As illustrated in FIG. 6, the image correction method generally includes an operation S100 of obtaining an image blurred due to movement of the camera module 1, a data generation operation of generating movement control data and position data of the lens 10 corresponding to movement of the camera module 1 during an image capturing period, and blurring removal operation of post-correcting the image using the movement control data and the position data to remove blurring from the image caused by movement of the camera module 1.

Referring to the data generation operation, angular velocity data representing a change in angular velocity of movement of the camera module 1 is detected during the image capturing period in operation S110. The angular velocity data includes information related to a change in angular velocity in the three axis directions and is obtained through the angular velocity sensor 110, namely, a gyro sensor. Thereafter, a movement angle of the lens 10 is calculated by integrating the detected angular velocity data, and a movement distance of the lens 10 is determined using Equation 1. Thus, movement control data including the movement direction and movement distance information is generated on the basis of the angular velocity data in operation S120. Thereafter, a position of the lens 10 upon being moved to correspond to movement of the camera module 1 is sensed to generate position data in operation S130.

The blurring removal operation includes error path detection operations S140 and S150 of detecting an error between the position data and the movement control data and calculating a path (or an image trajectory) of the error, respectively, an operation S160 of estimating a point spread function on the basis of the path of the error, and an operation S170 of subsequently applying deconvolution to the point spread function to remove blurring from the image.

In a case in which an image is blurred because the lens 10 is not accurately moved according to a control command, an error is detected using a differential value obtained by comparing movement control data and position data. The detected error may be formed as 3D coordinates, and a 3D path (or an image trajectory) during an image capturing period may be detected using the error in the form of 3D coordinates.

The blurred image, a sharp image, and the point spread function are in the relationship of Equation 2, and thus, blurring of the image is removed by estimating the point spread function on the basis of the 3D path and applying the deconvolution algorithm based on the Wiener filter scheme or the L2 scheme and the Levin scheme to the estimated point spread function.

The image correction method further includes an operation 180 of outputting the image without blurring to the user through the display 40.

As set forth above, in the image correction circuit and the image correction method, in order to remove blurring of an image caused as the lens 10 is not accurately moved to correspond to movement of the camera module 1, a point spread function is estimated using an error between movement control data and position data, and the deconvolution algorithm is applied to the estimated point spread function.

Since the movement control data and the position data include information regarding three axis directions, a 3D path (or an image trajectory) regarding the error can be calculated. Since blurring is removed to accurately correspond to movement on the 3D path, an image sharper than that of the related art can be obtained.

The apparatuses, units, modules, devices, and other components (e.g., the motion sensor 100, the angular velocity sensor 110, the position sensor 120 and the controller 200, the first processor 210, the second processor 220, the display 40, the image sensor 50, the optical driver 20 and the optical driving module 30) illustrated in FIG. 1 that perform the operations described herein with respect to FIG. 6 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIG. 6. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The method illustrated in FIG. 6 that performs the operations described herein with respect to FIGS. 1-5 is performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An image correction circuit, comprising:
a motion sensor configured to generate motion data corresponding to movement of a camera module during capturing of an image; and
a controller configured to post-correct the image using the motion data to remove blurring of the image caused by the movement of the camera module.

2. The image correction circuit of claim 1, wherein the motion sensor comprises:
an angular velocity sensor configured to generate angular velocity data representing a change in angular velocity based on the movement of the camera module; and
a position sensor configured to generate position data of a lens upon detecting a position of the lens.

3. The image correction circuit of claim 2, wherein the controller is configured to generate movement control data by determining a movement direction and a movement distance of the lens according to an angle obtained by integrating the angular velocity data.

4. The image correction circuit of claim 3, wherein the controller is configured to remove blurring of the image using an error between the movement control data and the position data.

5. The image correction circuit of claim 4, wherein the controller is configured to detect the error by comparing the movement control data and the position data, and calculate an image trajectory regarding the error, the image trajectory comprising information related to three axis directions.

6. The image correction circuit of claim 5, wherein the controller is configured to estimate a point spread function based on the image trajectory, and remove blurring from the image by applying deconvolution to the point spread function.

7. The image correction circuit of claim 2, wherein the controller comprises:
a first processor configured to generate movement control data comprising information regarding a movement direction and a movement distance of the lens using an angle calculated by integrating the angular velocity data; and
a second processor configured to detect an error using a differential value obtained by comparing the movement control data and the position data, generate a motion trajectory according to coordinates corresponding to the error, and apply deconvolution to a point spread function estimated on the basis of the image trajectory.

8. The image correction circuit of claim 2, wherein the position sensor comprises:
a first Hall sensor configured to sense an x-axis position of the lens;
a second Hall sensor configured to sense a y-axis position of the lens; and
a third Hall sensor configured to sense a z-axis position of the lens.

9. An image correction method, comprising:
performing a data generation operation comprising generating position data including movement control data of a lens and position information related to the lens according to movement of a camera module during capturing of an image; and
performing a blurring removal operation comprising post-correcting the image using the movement control data and the position data to remove blurring of the image caused by the movement of the camera module.

10. The image correction method of claim 9, wherein the performing of the data generation operation further comprises:
generating angular velocity data representing a change in angular velocity of the movement of the camera module;
calculating an angle by integrating the angular velocity data, and generating the movement control data by determining a movement direction and a movement distance of the lens on the basis of the calculated angle; and
detecting a position of the lens to generate the position data.

11. The image correction method of claim 9, wherein the performing of the blurring removal operation further comprises:
detecting an error between the position data and the movement control data to calculate an error path;
estimating a point spread function on the basis of the path of the error; and
removing blurring of the image by applying deconvolution to the point spread function.

12. The image correction method of claim 11, wherein:
the detecting of the error comprises detecting the error using a differential value obtained by comparing the movement control data and the position data; and
the calculating of the error path comprises detecting a three-dimensional path according to coordinates corresponding to the error.

13. A camera module comprising:
an image sensor configured to capture an image; and
a controller configured to
receive motion data corresponding to movement of the camera module during the capturing of the image, and
post-correct the image using the motion data to remove blurring of the image caused by the movement of the camera module.

14. The camera module of claim 13, wherein the motion data comprises angular velocity data representing a change in angular velocity based on the movement of the camera module, and position data of a lens.

15. The camera module of claim 14, wherein:
the controller is configured to generate movement control data by determining a movement direction and a movement distance of the lens according to an angle obtained by integrating the angular velocity data; and
the controller is configured to remove blurring of the image using an error between the movement control data and the position data.

16. The camera module of claim 15, wherein the controller is configured to:
calculate an image trajectory regarding the error, the image trajectory comprising information related to three axis directions;
estimate a point spread function based on the image trajectory; and
remove blurring from the image by applying deconvolution to the point spread function.
